(19) United States
(12) Patent Application Publication
(10) Pub. No.: US 2024/0371028 A1
(43) Pub. Date: Nov. 7, 2024

(54) IMAGE PROCESSING DEVICE, IMAGE PROCESSING METHOD, AND COMPUTER PROGRAM PRODUCT

(71) Applicant: Socionext Inc., Kanagawa (JP)

(72) Inventor: Kazuyuki OHHASHI, Yokohama (JP)

(21) Appl. No.: 18/771,325

(22) Filed: Jul. 12, 2024

Related U.S. Application Data
(63) Continuation of application No. PCT/JP2022/012911, filed on Mar. 18, 2022.

(51) Int. Cl. G06T 7/70; G06T 7/579; H04N 5/74

(52) U.S. Cl. CPC G06T 7/70; G06T 7/579; H04N 5/74; G06T 2207/30252

(57) ABSTRACT

According to one embodiment, an image processing device includes an action plan formulation module and a projection shape determination module. The action plan formulation module generates, based on action plan information of a moving body, first information including planned self-position information of the moving body and position information of a peripheral three-dimensional object based on the planned self-position information. The projection shape determination module determines, based on the first information, a shape of a projection surface on which a first image acquired by an imaging device mounted on the moving body is projected to generate a bird's-eye view image.

### CROSS-REFERENCE TO RELATED APPLICATIONS

This application is a continuation of International Application No. PCT/JP2022/012911, filed on Mar. 18, 2022, the entire contents of which are incorporated herein by reference.

### FIELD

Embodiments described herein relate generally to an image processing device, an image processing method, and a computer program product.

### BACKGROUND

There is a technique of generating a bird's-eye view image around a moving body such as a vehicle by using images of a plurality of cameras mounted on the moving body. There is a technique of changing a shape of a projection surface of a bird's-eye view image according to a three-dimensional object around a moving body. Further, there is a technology of acquiring position information around a moving body and determining an action path of the moving body by using Visual Simultaneous Localization and Mapping (referred to as VSLAM) or the like for performing SLAM using an image captured by a camera. For example, conventional technologies are described in patent documents, which are JP 2009-232310 A, JP 2013-207637 A, JP 2014-531078 W, WO 2021/111531 A, WO 2021/065241 A, and JP 2020-083140 A.

However, when the projection surface of the bird's-eye view image is sequentially deformed according to the three-dimensional object around the moving body, the deformation of the projection surface is delayed with respect to the movement of the moving body and the bird's-eye view image may be unnatural.

### SUMMARY

An image processing device according to the present disclosure includes: an action plan formulation module configured to generate, based on action plan information of a moving body, first information including planned self-position information indicating a planned self-position of the moving body and position information of a peripheral three-dimensional object based on the planned self-position information; and a projection shape determination module configured to determine, based on the first information, a shape of a projection surface on which a first image acquired by an imaging device mounted on the moving body is projected to generate a bird's-eye view image.

### BRIEF DESCRIPTION OF THE DRAWINGS

FIG. 1 is a diagram illustrating an example of an overall configuration of an information processing system according to an embodiment;

FIG. 2 is a diagram illustrating an example of a hardware configuration of an information processing device according to the embodiment;

FIG. 3 is a diagram illustrating an example of a functional configuration of the information processing device according to the embodiment;

FIG. 4 is a schematic diagram illustrating an example of environmental map information according to the embodiment;

FIG. 5 is a schematic diagram illustrating an example of a functional configuration of an action plan formulation module of the information processing device according to a first embodiment;

FIG. 6 is a schematic diagram illustrating an example of a parking route plan generated by a planning processing module;

FIG. 7 is a schematic diagram illustrating an example of planned map information generated by a planned map information generation module;

FIG. 8 is a schematic diagram illustrating an example of a functional configuration of a determination module of an information processing device according to the first embodiment;

FIG. 9 is a schematic diagram illustrating an example of a reference projection surface;

FIG. 10 is an explanatory diagram of an asymptotic curve generated by a determination module;

FIG. 11 is a schematic diagram illustrating an example of a projection shape determined by the determination module;

FIG. 12 is a flowchart illustrating an example of a flow of projection surface deformation processing based on an action plan;

FIG. 13 is a flowchart illustrating an example of a flow of bird's-eye view image generation processing including projection surface deformation processing based on an action plan, executed by the information processing device;

FIG. 14 is a diagram for explaining projection surface deformation processing executed by an information processing device according to a comparative example;

FIG. 15 is a diagram for explaining the projection surface deformation processing executed by the information processing device according to the comparative example;

FIG. 16 is a schematic diagram illustrating an example of a functional configuration of an information processing device according to a second embodiment;

FIG. 17 is a schematic diagram illustrating an example of a functional configuration of an action plan formulation module of the information processing device according to the second embodiment;

FIG. 18 is a schematic diagram illustrating an example of a functional configuration of an information processing device according to a third embodiment; and

FIG. 19 is a schematic diagram illustrating an example of a functional configuration of an action plan formulation module of the information processing device according to the third embodiment.

### DETAILED DESCRIPTION

Hereinafter, embodiments of an image processing device, an image processing method, and a computer program product disclosed in the present application will be explained in detail with reference to the accompanying drawings. Note that the following embodiments do not limit the disclosed technology. The embodiments can be combined as appropriate within a range in which processing contents do not contradict one another.

### First Embodiment

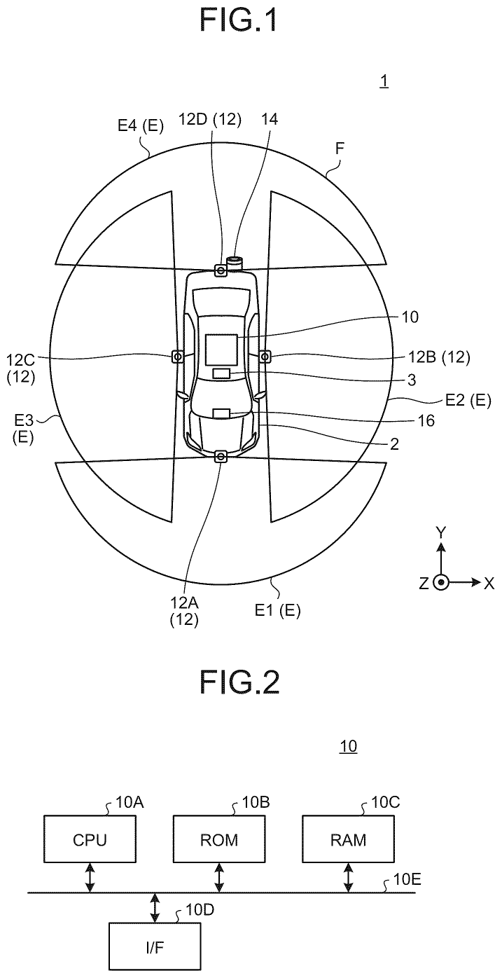

FIG. 1 is a diagram illustrating an example of an overall configuration of an information processing system 1 in an embodiment. The information processing system 1 includes an information processing device 10, an imaging unit 12, a detection unit 14, and a display unit 16. The information processing device 10, the imaging unit 12, the detection unit 14, and the display unit 16 are connected to be capable of exchanging data or signals. Note that the information processing device 10 is an example of the image processing device. An information processing method executed by the information processing device 10 is an example of the image processing method. An information processing program used by the information processing device 10 to execute the information processing method is an example of the image processing program.

In the present embodiment, a mode in which the information processing device 10, the imaging unit 12, the detection unit 14, and the display unit 16 are mounted on a moving body 2 is explained as an example.

The moving body 2 is a movable object. The moving body 2 is, for example, a vehicle, a flying object (a manned airplane, an unmanned airplane (for example, a UAV (Unmanned Aerial Vehicle) or a drone)), a robot, or the like. The moving body 2 is, for example, a moving body that travels via driving operation by a person or a moving body capable of automatically traveling (autonomously traveling) not via driving operation by a person. In the present embodiment, a case in which the moving body 2 is a vehicle is explained as an example. The vehicle is, for example, a two-wheeled automobile, a three-wheeled automobile, or a four-wheeled automobile. In the present embodiment, a case in which the vehicle is an autonomously travelable four-wheeled vehicle is explained as an example.

Note that all of the information processing device 10, the imaging unit 12, the detection unit 14, and the display unit 16 are not limited to the form of being mounted on the moving body 2. The information processing device 10 may be mounted on, for example, a stationary object. The stationary object is an object fixed to the ground. The stationary object is an immovable object or an object standing still on the ground. The stationary object is, for example, a traffic light, a parked vehicle, or a road sign. The information processing device 10 may be mounted on a cloud server that executes processing on the cloud.

The imaging unit 12 images the periphery of the moving body 2 and acquires captured image data. In the following explanation, the captured image data is simply referred to as captured image. The imaging unit 12 is, for example, a digital camera capable of imaging a moving image. Note that imaging indicates converting an image of a subject formed by an optical system such as a lens into an electric signal. The imaging unit 12 outputs the captured image to the information processing device 10. In the present embodiment, explanation is given on the assumption that the imaging unit 12 is a monocular fisheye camera (for example, a viewing angle is 195 degrees).

In the present embodiment, a mode in which four imaging units 12, that is, a front imaging unit 12A, a left imaging unit 12B, a right imaging unit 12C, and a rear imaging unit 12D are mounted on the moving body 2 is explained as an example. The plurality of imaging units 12 (the front imaging unit 12A, the left imaging unit 12B, the right imaging unit 12C, and the rear imaging unit 12D) respectively image subjects in imaging regions E (a front imaging region E1, a left imaging region E2, a right imaging region E3, and a rear imaging region E4) in different directions to acquire captured images. That is, it is assumed that the plurality of imaging units 12 have different imaging directions. It is assumed that the imaging directions of the plurality of imaging units 12 are adjusted in advance such that at least parts of the imaging regions E overlap among the imaging units 12 adjacent to one another. In FIG. 1, the imaging regions E are illustrated in sizes illustrated in FIG. 1 for convenience of explanation. However, actually, the imaging regions E include regions further away from the moving body 2.

The four front imaging unit 12A, left imaging unit 12B, right imaging unit 12C, and rear imaging unit 12D are examples. The number of the imaging units 12 is not limited. For example, when the moving body 2 has a vertically long shape like a bus or a truck, it is also possible to dispose the imaging units 12 one by one in the front, the rear, the front of the right side surface, the rear of the right side surface, the front of the left side surface, and the rear of the left side surface of the moving body 2 and use six imaging units 12 in total. That is, the number and disposition positions of the imaging units 12 can be optionally set according to the size and the shape of the moving body 2.

The detection unit 14 detects position information of each of a plurality of detection points around the moving body 2. In other words, the detection unit 14 detects position information of each of detection points in a detection region F. The detection point indicates each of points individually observed by the detection unit 14 in a real space. The detection point corresponds to, for example, a three-dimensional object around the moving body 2. Note that the detection unit 14 is an example of an external sensor.

The detection unit 14 is, for example, a 3D (Three-Dimensional) scanner, a 2D (Two Dimensional) scanner, a distance sensor (a millimeter wave radar or a laser sensor), a sonar sensor that detects an object with sound waves, or an ultrasonic sensor. The laser sensor is, for example, a three-dimensional LiDAR (Laser imaging Detection and Ranging) sensor. The detection unit 14 may be a device using a technique of measuring a distance from an image captured by a stereo camera or a monocular camera, for example, a SfM (Structure from Motion) technique. The plurality of imaging units 12 may be used as the detection unit 14. One of the plurality of imaging units 12 may be used as the detection unit 14.

The display unit 16 displays various kinds of information. The display unit 16 is, for example, an LCD (Liquid Crystal Display) or an organic EL (Electro-Luminescence) display.

In the present embodiment, the information processing device 10 is communicably connected to an electronic control unit (ECU) 3 mounted on the moving body 2. The ECU 3 is a unit that performs electronic control for the moving body 2. In the present embodiment, it is assumed that the information processing device 10 is capable of receiving CAN (Controller Area Network) data such as speed and a moving direction of the moving body 2 from the ECU 3.

Next, a hardware configuration of the information processing device 10 is explained.

FIG. 2 is a diagram illustrating an example of the hardware configuration of the information processing device 10.

The information processing device 10 includes a CPU (Central Processing Unit) 10A, a ROM (Read Only Memory) 10B, a RAM (Random Access Memory) 10C, and an I/F (InterFace) 10D and is, for example, a computer. The CPU 10A, the ROM 10B, the RAM10C, and the I/F 10D are connected to one another by a bus 10E and have a hardware configuration using a normal computer.

The CPU 10A is an arithmetic device that controls the information processing device 10. The CPU 10A corresponds to an example of a hardware processor. The ROM 10B stores programs and the like for implementing various kinds of processing by the CPU 10A. The RAM10C stores data necessary for the various kinds of processing by the CPU 10A. The I/F 10D is an interface for connecting to the imaging unit 12, the detection unit 14, the display unit 16, the ECU 3, and the like and transmitting and receiving data.

A program for executing information processing executed by the information processing device 10 in the present embodiment is provided by being incorporated in the ROM 10B or the like in advance. Note that the program executed by the information processing device 10 in the present embodiment may be configured to be provided by being recorded in a recording medium as a file in a format installable in the information processing device 10 or an executable format. The recording medium is a computer-readable medium. The recording medium is a CD (Compact Disc)-ROM, a flexible disk (FD), a CD-R (Recordable), a DVD (Digital Versatile Disk), a USB (Universal Serial Bus) memory, an SD (Secure Digital) card, or the like.

Next, a functional configuration of the information processing device 10 according to the present embodiment is explained. The information processing device 10 simultaneously estimates, with VSLAM processing, surrounding position information of the moving body 2 and self-position information of the moving body 2 from a captured image captured by the imaging unit 12. The information processing device 10 connects a plurality of spatially adjacent captured images to generate a combined image (a bird's-eye view image) overlooking the periphery of the moving body 2 and displays the combined image. Note that, in the present embodiment, the imaging unit 12 is used as the detection unit 14.

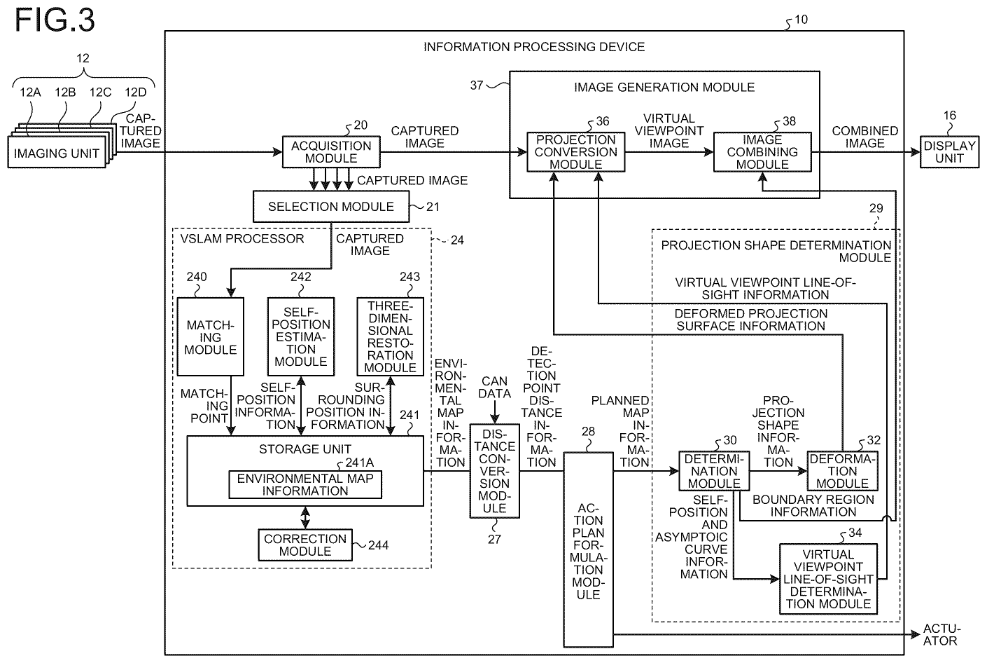

FIG. 3 is a diagram illustrating an example of a functional configuration of the information processing device 10. Note that, in order to clarify a data input/output relation, FIG. 3 also illustrates the imaging unit 12 and the display unit 16 in addition to the information processing device 10.

The information processing device 10 includes an acquisition module 20, a selection module 21, a VSLAM processor 24, a distance conversion module 27, an action plan formulation module 28, a projection shape determination module 29, and an image generation module 37.

A part or all of the plurality of units may be implemented, for example, by causing a processing device such as the CPU 10A to execute a program, that is, by software. A part or all of the plurality of units may be implemented by hardware such as an IC (Integrated Circuit) or may be implemented by using software and hardware in combination.

The acquisition module 20 acquires a captured image from the imaging unit 12. That is, the acquisition module 20 acquires a captured image from each of the front imaging unit 12A, the left imaging unit 12B, the right imaging unit 12C, and the rear imaging unit 12D.

Every time the acquisition module 20 acquires a captured image, the acquisition module 20 delivers the acquired captured image to a projection conversion module 36 and the selection module 21.

The selection module 21 selects a detection region of a detection point. In the present embodiment, the selection module 21 selects the detection region by selecting at least one imaging unit 12 among the plurality of imaging units 12 (the imaging units 12A to 12D).

The VSLAM processor 24 generates second information including position information of a peripheral three-dimensional object of the moving body 2 and position information of the moving body 2 based on an image of the periphery of the moving body 2. That is, the VSLAM processor 24 receives the captured image from the selection module 21, executes VSLAM processing using the captured image to generate environmental map information, and outputs the generated environmental map information to a determination module 30.

More specifically, the VSLAM processor 24 includes a matching module 240, a storage unit 241, a self-position estimation module 242, a three-dimensional restoration module 243, and a correction module 244.

The matching module 240 performs feature value extraction processing and matching processing between images on a plurality of captured images at different imaging timings (a plurality of captured images in different frames). Specifically, the matching module 240 performs the feature value extraction processing from the plurality of captured images. The matching module 240 performs, on the plurality of captured images at different imaging timings, matching processing of specifying corresponding points among the plurality of captured images by using feature values among the plurality of captured images. The matching module 240 outputs a result of the matching processing to the storage unit 241.

The self-position estimation module 242 estimates a relative self-position with respect to a captured image with projective conversion or the like using the plurality of matching points acquired by the matching module 240. Here, the self-position includes information concerning the position (a three-dimensional coordinate) and inclination (rotation) of the imaging unit 12. The self-position estimation module 242 stores the self-position information as point group information in environmental map information 241A.

The three-dimensional restoration module 243 performs perspective projection conversion processing using a movement amount (a translation amount and a rotation amount) of the self-position estimated by the self-position estimation module 242 and determines a three-dimensional coordinate (a relative coordinate with respect to the self-position) of the matching point. The three-dimensional restoration module 243 stores surrounding position information, which is the determined three-dimensional coordinate, in the environmental map information 241A as point group information.

Accordingly, new surrounding position information and new self-position information are sequentially added to the environmental map information 241A according to the movement of the moving body 2 mounted with the imaging unit 12.

The storage unit 241 stores various data. The storage unit 241 is, for example, a semiconductor memory element such as a RAM or a flash memory, a hard disk, or an optical disk. Note that the storage unit 241 may be a storage device provided on the outside of the information processing device 10. The storage unit 241 may be a storage medium. Specifically, the storage medium may store or temporarily store a program or various kinds of information downloaded via a LAN (Local Area Network), the Internet, or the like.

The environmental map information 241A is information in which point group information, which is the surrounding position information calculated by the three-dimensional restoration module 243, and point group information, which is the self-position information calculated by the self-position estimation module 242, are registered in a three-dimensional coordinate space having a predetermined position in the real space as an origin (a reference position). The predetermined position in the real space may be decided based on, for example, a preset condition.

For example, the predetermined position used for the environmental map information 241A is the self-position of the moving body 2 at the time when the information processing device 10 executes the information processing in the present embodiment. For example, a case in which the information processing is executed at predetermined timing such as a parking scene of the moving body 2 is assumed. In this case, the information processing device 10 only has to set, as the predetermined position, the self-position of the moving body 2 at the time when discriminating that the predetermined timing has been reached. For example, when discriminating that the behavior of the moving body 2 has become a behavior indicating a parking scene, the information processing device 10 only has to determine that the predetermined timing has been reached. A behavior indicating a parking scene caused by a backward movement is, for example, a case in which the speed of the moving body 2 becomes equal to or lower than predetermined speed, a case in which a gear of the moving body 2 is shifted into the back gear, a case in which a signal indicating the start of parking is received according an operation instruction of a user. Note that the predetermined timing is not limited to the parking scene.

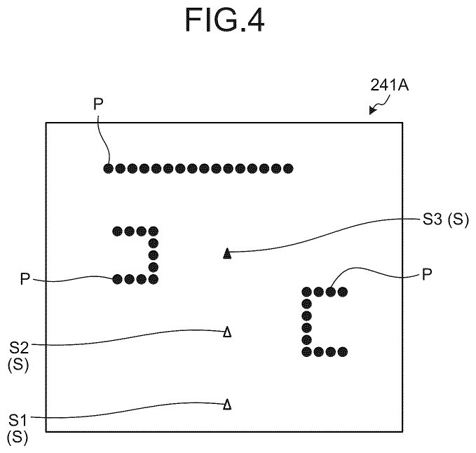

FIG. 4 is a schematic diagram of an example in which information concerning a specific height in the environmental map information 241A is extracted. As illustrated in FIG. 4, the environmental map information 241A is information in which point group information, which is position information (surrounding position information) of each of detection points P, and point group information, which is self-position information of self-positions S of the moving body 2, are registered at corresponding coordinate positions in a three-dimensional coordinate space. Note that, in FIG. 4, the self-position S, that is, a self-position S1 to a self-position S3, are illustrated as an example. A larger value of a numerical value following S means that the self-position S is closer to current timing.

The correction module 244 corrects, for points matched a plurality of times among a plurality of frames, surrounding position information and self-position information registered in the environmental map information 241A using, for example, the least squares method such that the sum of the differences in distance in a three-dimensional space is minimized between a three-dimensional coordinate calculated in the past and a three-dimensional coordinate calculated anew. Note that the correction module 244 may correct a movement amount (a translation amount and a rotation amount) of the self-position used in a process of calculating the self-position information and the surrounding position information.

Timing of correction processing by the correction module 244 is not limited. For example, the correction module 244 only has to execute the correction processing at every predetermined timing. The predetermined timing may be decided based on, for example, a preset condition. Note that, in the present embodiment, a case in which the information processing device 10 includes the correction module 244 is explained as an example. However, the information processing device 10 may not include the correction module 244.

The distance conversion module 27 converts a relative positional relations between a self-position and a peripheral three-dimensional object, which can be known by the environmental map information, into the absolute value of the distance from the self-position to the peripheral three-dimensional object, generates detection point distance information of the peripheral three-dimensional object, and outputs the detection point distance information to the action plan formulation module 28. Here, the detection point distance information of the peripheral three-dimensional object is information obtained by offsetting the self-position to a coordinate (0, 0, 0) and converting a calculated measurement distance (coordinate) to each of a plurality of detection points P into, for example, meter unit. That is, the information concerning the self-position of the moving body 2 is included as the coordinate (0, 0, 0) of the origin in the detection point distance information.

In the distance conversion executed by the distance conversion module 27, for example, vehicle state information such as speed data of the moving body 2 included in CAN data delivered from the ECU 3 is used. For example, in the case of the environmental map information 241A illustrated in FIG. 4, a relative positional relation between the self-positions S and the plurality of detection points P can be known but the absolute value of the distance is not calculated. Here, the distance between the self-position S3 and the self-position S2 can be calculated from an inter-frame period in which self-position calculation is performed and speed data in the inter-frame period according to the vehicle state information. Since a relative positional relation of the environmental map information 241A is a similar relation to that of the real space, the absolute value of the distances from the self-positions S to all the other detection points P can also be calculated because the distance between the self-position S3 and the self-position S2 is known. That is, the distance conversion module 27 converts the relative positional relation between the self-position and the peripheral three-dimensional object into the absolute value of the distance from the self-position to the peripheral three-dimensional object using actual speed data of the moving body 2 included in the CAN data.

Note that the vehicle state information included in the CAN data and the environmental map information output from the VSLAM processor 24 can be associated by time information. When the detection unit 14 acquires distance information of the detection points P, the distance conversion module 27 may be omitted.

The action plan formulation module 28 formulates an action plan of the moving body 2 based on second information including the position information (the detection point distance information) of the peripheral three-dimensional object of the moving body 2 and generates first information including planned self-position information of the moving body 2 and position information of the peripheral three-dimensional object based on planned self-position information of the moving body 2.

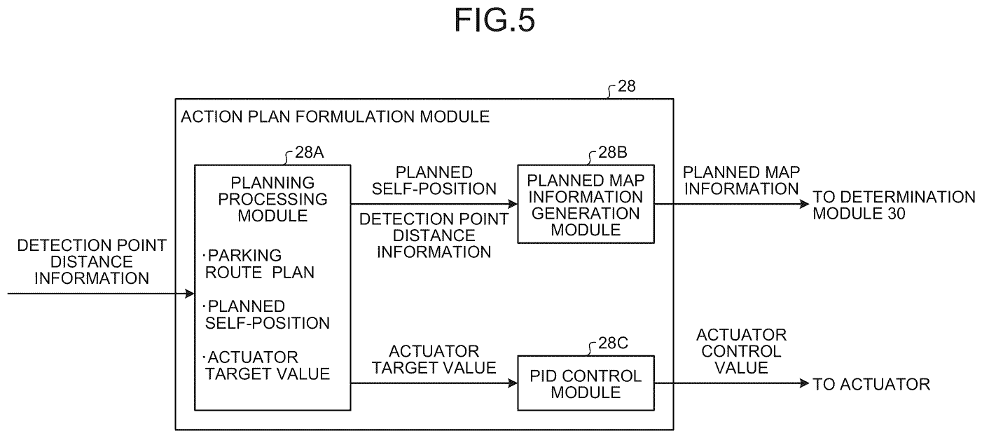

FIG. 5 is a schematic diagram illustrating an example of a functional configuration of the action plan formulation module 28. As illustrated in FIG. 5, the action plan formulation module 28 includes a planning processing module 28A, a planned map information generation module 28B, and a PID control module 28C.

The planning processing module 28A executes planning processing based on the detection point distance information received from the distance conversion module 27, for example, in response to an automatic parking mode selection instruction from a driver. Here, the planning processing executed by the planning processing module 28A is processing of formulating a parking route from a current position of the moving body 2 to a parking completion position for parking the moving body 2 in a parking region, a planned self-position of the moving body 2 after a unit time, which is a most recent target point obtained by engraving the parking route, an actuator target value such as most recent acceleration or turn angle for reaching the most recent target point, and the like.

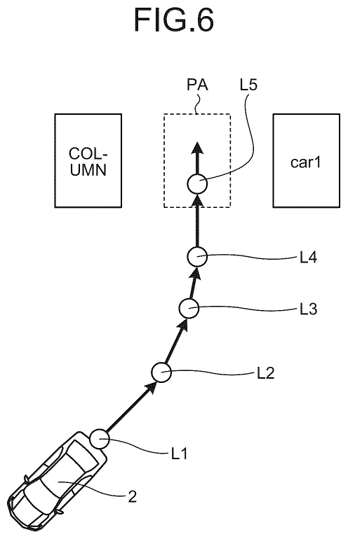

FIG. 6 is a schematic diagram illustrating an example of a parking route plan generated by the planning processing module 28A. As illustrated in FIG. 6, the parking route plan is information including a route from a current position L1 to the parking completion position through planned via-points L2, L3, L4, and L5 when backward parking is performed in the parking area PA. The planned via-points L2, L3, L4, and L5 are planned via-points of the moving body 2 for each unit time at present. Therefore, the distances between the current position L1 and the respective planned via-points L2, L3, L4, and L5 may change according to the moving speed of the moving body 2. Here, the unit time is, for example, a time interval corresponding to a frame rate of the VSLAM processing. In addition, the planned via-point L2 is also a planned self-position with respect to the current position L1. The parking route plan is updated based on the latest detection point distance information at a position where the moving body 2 moves from the current position L1 toward the planned via-point L2 and the unit time has elapsed. In this case, the position in the case in which the unit time has elapsed may coincide with the planned via-point L2 with respect to the current position L1 or may be a position deviating from the planned via-point L2.

Note that a specific calculation method for the parking route plan explained above is not particularly limited and may be any method if information including a planned self-position where the moving body 2 should be located after the next unit time elapses can be acquired every time the unit time elapses.

In the present embodiment, a case in which the action plan formulation module 28 includes the planning processing module 28A and the planning processing module 28A sequentially formulates an action plan is explained. In contrast, the action plan formulation module 28 may not include the planning processing module 28A and may be configured to sequentially acquire an action plan of the moving body 2 formulated outside.

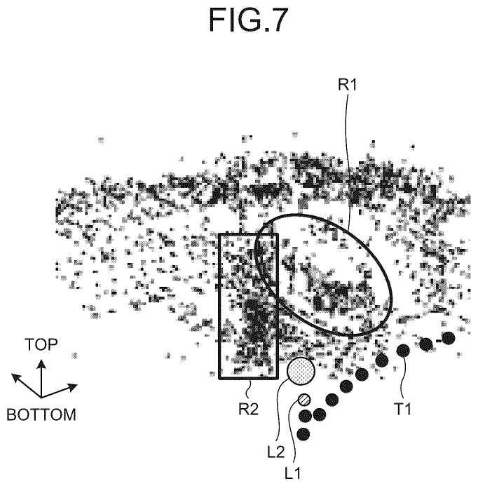

The planned map information generation module 28B offsets the origin (a current self-position) of the detection point distance information to the planned self-position after a unit time. FIG. 7 is a schematic diagram for explaining the planned map information generated by the planned map information generation module 28B. In FIG. 7, detection point distance information (a plurality of pieces of point group information) around the moving body 2 is illustrated as the planned map information. In FIG. 7, a region R1, a region R2, a track T1, and positions L1 and L2 are additionally written for explanation A point group present in the region R1 corresponds to another moving body (car 1) present next to the parking region PA where the moving body 2 should be parked. A point group present in the region R2 corresponds to a column present in the vicinity of the parking region PA. The track T1 indicates a track at the time when the moving body 2 travels forward from the right side to the left side in the drawing, temporarily stops, and travels backward and is parked in the parking region PA. The position L1 indicates a current self-position of the moving body 2 and the position L2 indicates a planned self-position of the moving body 2 at timing in future by a unit time. The planned map information generation module 28B offsets detection point distance information having a current position L1 as the origin using the planned self-position L2 as the origin to generate planned map information viewed from a planned self-position after a unit time.

Every time the self-position of the moving body 2 and the position information of the peripheral three-dimensional object of the moving body 2 are updated by the VSLAM processing, the planned map information generation module 28B offsets the origin (the current self-position) of the updated detection point distance information to a planned self-position after the unit time. The planned map information generation module 28B generates planned map information in which the origin is offset to the planned self-position and delivers the planned map information to the determination module 30.

The PID control module 28C performs PID (Proportional Integral Differential) control based on the actuator target value formulated by the planning processing module 28A and delivers an actuator control value for controlling an actuator such as acceleration or a turning angle. For example, the PID control module 28C updates the actuator control value every time the planning processing module 28A updates the actuator target value and delivers the updated actuator control value to the actuator. The PID control module 28C is an example of the control information generation module.

Referring back to FIG. 3, the projection shape determination module 29 determines, based on the first information, a shape of a projection surface for projecting an image acquired by an imaging device 12 mounted on the moving body 2 to generate a bird's-eye view image. The projection shape determination module 29 is an example of the projection shape determination module.

Here, the projection surface is a stereoscopic plane for projecting a peripheral image of the moving body 2 as a bird's-eye view image. The peripheral image of the moving body 2 is a captured image of the periphery of the moving body 2 and is a captured image captured by each of the imaging unit 12A to the imaging unit 12D. The projection shape of the projection surface is a three-dimensional (3D) shape virtually formed in a virtual space corresponding to the real space. The image to be projected on the projection surface may be the same image as the image used when the VSLAM processor 24 generates the second information or may be an image acquired at a different time or an image subjected to different image processing. In the present embodiment, the determination of the projection shape of the projection surface executed by the projection shape determination module 29 is referred to as projection shape determination processing.

Specifically, the projection shape determination module 29 includes a determination module 30, a deformation module 32, and a virtual viewpoint line-of-sight determination module 34.

### Configuration Example of the Determination Module 30

An example of a detailed configuration of the determination module 30 illustrated in FIG. 3 is explained below.

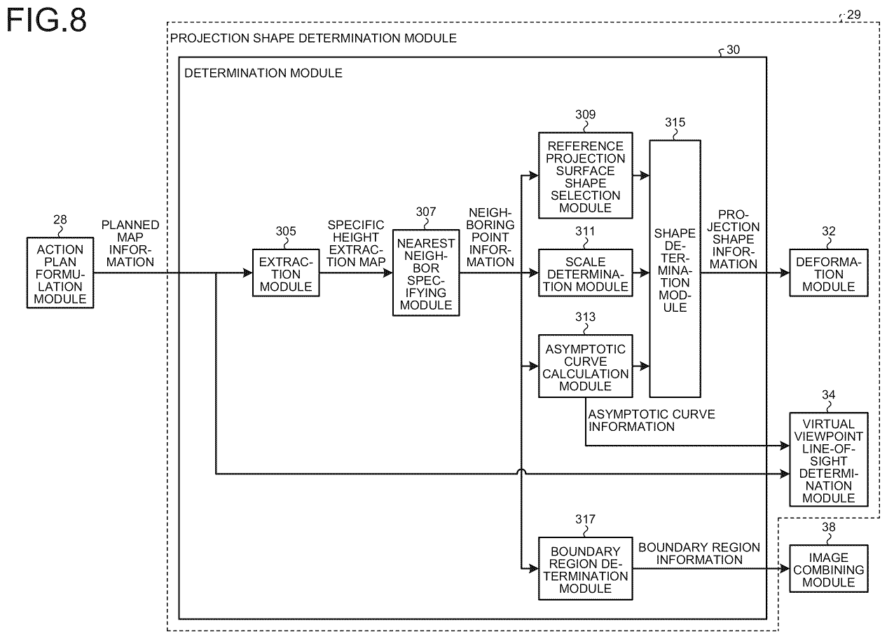

FIG. 8 is a schematic diagram illustrating an example of a functional configuration of the determination module 30. As illustrated in FIG. 8, the determination module 30 includes an extraction module 305, a nearest neighbor specifying module 307, a reference projection surface shape selection module 309, a scale determination module 311, an asymptotic curve calculation module 313, a shape determination module 315, and a boundary region determination module 317.

The extraction module 305 extracts the detection point P present within a specific range among the plurality of detection points P, measurement distances of which are received from the distance conversion module 27, and generates a specific height extraction map. The specific range is, for example, a range from a road surface on which the moving body 2 is disposed to a height corresponding to the vehicle height of the moving body 2. Note that the range is not limited to this range.

The extraction module 305 extracts the detection point P within the range and generates the specific height extraction map, whereby, for example, it is possible to extract the detection point P of an object that hinders the traveling of the moving body 2 an object located adjacent to the moving body 2, or the like.

The extraction module 305 outputs the generated specific height extraction map to the nearest neighbor specifying module 307.

The nearest neighbor specifying module 307 divides the periphery of a planned self-position S′ of the moving body 2 for each specific range (for example, angular range) using the specific height extraction map, specifies, for each range, the detection point P closest to the planned self-position S′ of the moving body 2 or a plurality of detection points P in the order of closeness to the planned self-position S′ of the moving body 2, and generates neighboring point information. In the present embodiment, a mode in which the nearest neighbor specifying module 307 specifies, for each range, the plurality of detection points P in order of closeness to the planned self-position S′ of the moving body 2 and generates the neighboring point information is explained as an example.

The nearest neighbor specifying module 307 outputs the measurement distance of the detection point P specified for each range as the neighboring point information to the reference projection surface shape selection module 309, the scale determination module 311, the asymptotic curve calculation module 313, and the boundary region determination module 317.

The reference projection surface shape selection module 309 selects a shape of the reference projection surface based on the neighboring point information.

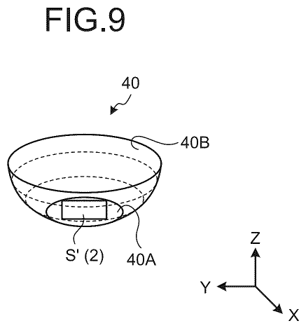

FIG. 9 is a schematic diagram illustrating an example of a reference projection surface 40. The reference projection surface is explained with reference to FIG. 9. The reference projection surface 40 is, for example, a projection surface having a shape serving as a reference when the shape of the projection surface is changed. The shape of the reference projection surface 40 is, for example, a bowl shape, a cylindrical shape, or the like. Note that FIG. 9 exemplifies a bowl-shaped reference projection surface 40.

The bowl shape is a shape including a bottom surface 40A and a side wall surface 40B, one end of the side wall surface 40B continuing to the bottom surface 40A and the other end being opened. The width of the horizontal cross section of the side wall surface 40B increases from the bottom surface 40A side toward the opening side of the other end portion. The bottom surface 40A has, for example, a circular shape. Here, the circular shape is a shape including a perfect circular shape and a circular shape other than the perfect circular shape such as an elliptical shape. The horizontal cross section is an orthogonal plane orthogonal to the vertical direction (an arrow Z direction). The orthogonal plane is a two-dimensional plane extending along an arrow X direction orthogonal to the arrow Z direction and an arrow Y direction orthogonal to the arrow Z direction and the arrow X direction. In the following explanation, the horizontal cross section and the orthogonal plane is sometimes referred to as an XY plane. Note that the bottom surface 40A may have a shape other than the circular shape such as an egg shape.

The cylindrical shape is a shape including a circular bottom surface 40A and a side wall surface 40B continuous to the bottom surface 40A. The side wall surface 40B configuring the cylindrical reference projection surface 40 has a cylindrical shape, an opening at one end portion of which is continuous to the bottom surface 40A and the other end portion of which is opened. However, the side wall surface 40B configuring the cylindrical reference projection surface 40 has a shape, the diameter of an XY plane of which is substantially constant from the bottom surface 40A side toward the opening side of the other end portion. Note that the bottom surface 40A may have a shape other than the circular shape such as an egg shape.

In the present embodiment, a case in which the shape of the reference projection surface 40 is the bowl shape illustrated in FIG. 9 is explained as an example. The reference projection surface 40 is a stereoscopic model virtually formed in a virtual space in which the bottom surface 40A is a surface substantially coinciding with a road surface below the moving body 2 and the center of the bottom surface 40A is a planned self-position S′ of the moving body 2.

The reference projection surface shape selection module 309 reads one specific shape from a plurality of kinds of reference projection surfaces 40 to select a shape of the reference projection surface 40. For example, the reference projection surface shape selection module 309 selects the shape of the reference projection surface 40 according to a positional relation, a distance, and the like between the planned self-position and a peripheral three-dimensional object. Note that the reference projection surface shape selection module 309 may select the shape of the reference projection surface 40 according to an operation instruction of the user. The reference projection surface shape selection module 309 outputs determined shape information of the reference projection surface 40 to the shape determination module 315. In the present exemplary embodiment, as explained above, a mode in which the reference projection surface shape selection module 309 selects the bowl-shaped reference projection surface 40 is explained as an example.

The scale determination module 311 determines a scale of the reference projection surface 40 having the shape selected by reference projection surface shape selection module 309. For example, the scale determination module 311 determines to, for example, reduce the scale when the distance from the planned self-position S′ to a neighboring point is shorter than a predetermined distance. The scale determination module 311 outputs scale information of the determined scale to the shape determination module 315.

The asymptotic curve calculation module 313 calculates an asymptotic curve of surrounding position information with respect to the planned self-position based on planned map information. The asymptotic curve calculation module 313 outputs asymptotic curve information of a calculated asymptotic curve Q to the shape determination module 315 and the virtual viewpoint line-of-sight determination module 34 using each distance from the planned self-position S′ to the closest detection point P for each range from the planned self-position S′ received from the nearest neighbor specifying module 307.

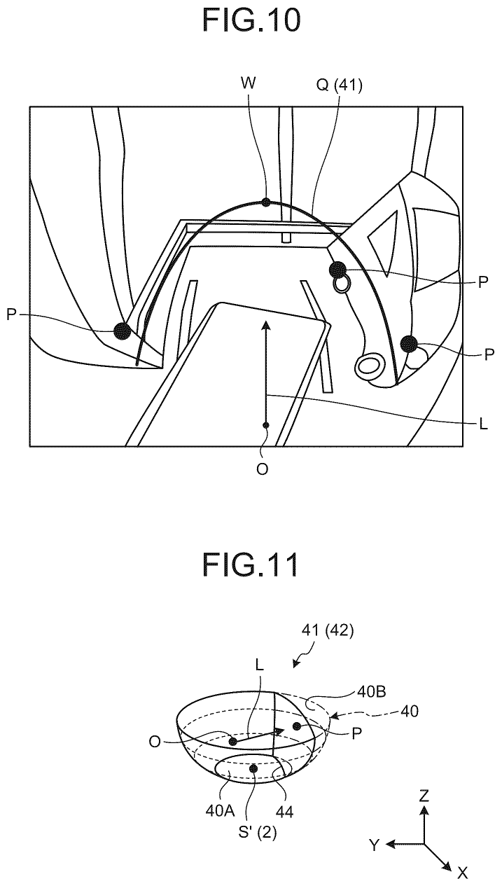

FIG. 10 is an explanatory diagram of the asymptotic curve Q generated by the determination module 30. Here, the asymptotic curve is an asymptotic curve of a plurality of detection points P in the planned map information. FIG. 10 illustrates an example in which the asymptotic curve Q is illustrated in a projection image obtained by projecting a captured image on a projection surface in the case in which the moving body 2 is overviewed from above. For example, it is assumed that the determination module 30 specifies three detection points P in order of closeness to the planned self-position S′ of the moving body 2. In this case, the determination module 30 generates the asymptotic curves Q of these three detection points P.

Note that the asymptotic curve calculation module 313 may calculate a representative point located at the center of gravity or the like of the plurality of detection points P for each specific range (for example, angular range) of the reference projection surface 40 and calculate the asymptotic curve Q for the representative point for each of the plurality of ranges. Then, the asymptotic curve calculation module 313 outputs asymptotic curve information of the calculated asymptotic curve Q to the shape determination module 315. Note that the asymptotic curve calculation module 313 may output the asymptotic curve information of the calculated asymptotic curve Q to the virtual viewpoint line-of-sight determination module 34.

The shape determination module 315 enlarges or reduces the reference projection surface 40 having the shape indicated by the shape information received from the reference projection surface shape selection module 309 to the scale of the scale information received from the scale determination module 311. The shape determination module 315 determines, as a projection shape, a shape deformed to be a shape along the asymptotic curve information of the asymptotic curve Q received from the asymptotic curve calculation module 313 with respect to the enlarged or reduced reference projection surface 40.

Here, the determination of the projection shape is explained in detail. FIG. 11 is a schematic diagram illustrating an example of a projection shape 41 determined by the determination module 30. As illustrated in FIG. 11, the shape determination module 315 determines, as the projection shape 41, a shape obtained by deforming the reference projection surface 40 into a shape passing through the detection point P closest to the planned self-position S′ of the moving body 2, which is the center of the bottom surface 40A of the reference projection surface 40. The shape passing through the detection point P means that the side wall surface 40B after deformation has a shape passing through the detection point P. The planned self-position S′ is determined by the action plan formulation module 28.

That is, the shape determination module 315 specifies the detection point P closest to the planned self-position S′ among the plurality of detection points P registered in the planned map information. Specifically, the shape determination module 315 determines an XY coordinate of the center position (the planned self-position S′) of the moving body 2 as (X, Y)=(0, 0). The shape determination module 315 specifies the detection point P at which a value of X²+Y² indicates a minimum value as the detection point P closest to the planned self-position S′. The shape determination module 315 determines, as the projection shape 41, a shape obtained by deforming the side wall surface 40B of the reference projection surface 40 to have a shape passing through the detection point P.

More specifically, the shape determination module 315 determines a deformed shape of partial regions of the bottom surface 40A and the side wall surface 40B as the projection shape 41 such that the partial region of the side wall surface 40B becomes a wall surface passing through the detection point P closest to the planned self-position S′ of the moving body 2 when the reference projection surface 40 is deformed. The deformed projection shape 41 is, for example, a shape raised from a rising line 44 on the bottom surface 40A toward a direction approaching the center of the bottom surface 40A at the viewpoint of the XY plane (in plan view). Raising means, for example, bending or folding parts of the side wall surface 40B and the bottom surface 40A toward a direction approaching the center of the bottom surface 40A such that an angle formed by the side wall surface 40B and the bottom surface 40A of the reference projection surface 40 becomes a smaller angle. Note that, in the raised shape, the rising line 44 may be located between the bottom surface 40A and the side wall surface 40B and the bottom surface 40A may remain not deformed.

The shape determination module 315 determines a specific region on the reference projection surface 40 to be deformed to protrude to a position passing through the detection point P at a viewpoint (in a plan view) of the XY plane. The shape and the range of the specific region may be determined based on a predetermined standard. The shape determination module 315 determines the shape of the deformed reference projection surface 40 such that the distance from the planned self-position S′ continuously increases from the protruded specific region toward a region other than the specific region on the side wall surface 40B.

For example, as illustrated in FIG. 11, it is preferable to determine the projection shape 41 such that the shape of the outer periphery of the cross section along the XY plane is a curved shape. Note that the shape of the outer periphery of the cross section of the projection shape 41 is, for example, a circular shape but may be a shape other than the circular shape.

Note that the shape determination module 315 may determine, as the projection shape 41, a shape obtained by deforming the reference projection surface 40 to have a shape extending along the asymptotic curve. The shape determination module 315 generates an asymptotic curve of a predetermined number of the plurality of detection points P in a direction away from the detection point P closest to the planned self-position S′ of the moving body 2. The number of detection points P only has to be plural. For example, the number of detection points P is preferably three or more. In this case, the shape determination module 315 preferably generates an asymptotic curve of a plurality of detection points P present at positions separated by a predetermined angle or more as viewed from the planned self-position S′. For example, the shape determination module 315 can determine, as the projection shape 41, a shape obtained by deforming the reference projection surface 40 to have a shape extending along the generated asymptotic curve Q in the asymptotic curve Q illustrated in FIG. 10.

Note that the shape determination module 315 may divide the periphery of the planned self-position S′ of the moving body 2 for each specific range and specify, for each range, the detection point P closest to the moving body 2 or a plurality of detection points P in order of closeness to the moving body 2. The shape determination module 315 may determine, as the projection shape 41, a shape obtained by deforming the reference projection surface 40 have a shape passing through the detection points P specified for each range or a shape extending along the asymptotic curve Q of the plurality of specified detection points P.

The shape determination module 315 outputs the determined projection shape information of the projection shape 41 to the deformation module 32.

Referring back to FIG. 3, the deformation module 32 deforms the projection surface based on the projection shape information determined using the planned map information received from the determination module 30. That is, the deformation module 32 deforms the projection surface using the three-dimensional point group data in which the origin is offset to the planned self-position S′ after the unit time elapses (for example, of the next frame) based on the action plan. This deformation of the reference projection surface is executed with reference to, for example, the detection point P closest to the planned self-position S′ of the moving body 2. The deformation module 32 outputs deformed projection surface information to the projection conversion module 36.

For example, the deformation module 32 deforms, based on the projection shape information, the reference projection surface into a shape extending along an asymptotic curve of a number of the plurality of detection points P predetermined in the order of closeness to the planned self-position S′ of the moving body 2.

The virtual viewpoint line-of-sight determination module 34 determines virtual viewpoint line-of-sight information based on the planned self-position S′ and the asymptotic curve information and delivers the virtual viewpoint line-of-sight information to the projection conversion module 36.

The determination of the virtual viewpoint line-of-sight information is explained with reference to FIG. 10 and FIG. 11. The virtual viewpoint line-of-sight determination module 34 determines, as a line-of-sight direction, for example, a direction that passes through the detection point P closest to the planned self-position S′ of the moving body 2 and is perpendicular to the deformed projection surface. For example, the virtual viewpoint line-of-sight determination module 34 fixes a direction of the line-of-sight direction L and determines coordinates of a virtual viewpoint O as any Z coordinate and any XY coordinate in a direction away from the asymptotic curve Q toward the planned self-position S′. In that case, the XY coordinate may be a coordinate at a position farther away from the asymptotic curve Q than the planned self-position S′. Then, the virtual viewpoint line-of-sight determination module 34 outputs virtual viewpoint line-of-sight information indicating the virtual viewpoint O and the line-of-sight direction L to the projection conversion module 36. Note that, as illustrated in FIG. 10, the line-of-sight direction L may be a direction from the virtual viewpoint O toward the position of a vertex W of the asymptotic curve Q.

The image generation module 37 generates a bird's-eye view image around the moving body 2 using the projection surface. Specifically, the image generation module 37 includes a projection conversion module 36 and an image combining module 38.

The projection conversion module 36 generates a projection image obtained by projecting a captured image acquired from the imaging unit 12 on the deformed projection surface based on the deformed projection surface information and the virtual viewpoint line-of-sight information. The projection conversion module 36 converts the generated projection image into a virtual viewpoint image and outputs the virtual viewpoint image to the image combining module 38. Here, the virtual viewpoint image is an image in which the projection image is visually recognized in any direction from a virtual viewpoint.

Projection image generation processing by the projection conversion module 36 is explained in detail with reference to FIG. 11. The projection conversion module 36 projects a captured image onto a deformed projection surface 42. The projection conversion module 36 generates a virtual viewpoint image that is an image obtained by visually recognizing the captured image projected on the deformed projection surface 42 in the line-of-sight direction L from any virtual viewpoint O (not illustrated). The position of the virtual viewpoint O only has to be, for example, the planned self-position S′ of the moving body 2 (set as a reference for the projection surface deformation processing). In this case, a value of the XY coordinate of the virtual viewpoint O only has to be set as a value of the XY coordinate of the planned self-position S′ of the moving body 2. A value of a Z coordinate (a position in the vertical direction) of the virtual viewpoint O only has to be set as value of a Z coordinate of the detection point P closest to the planned self-position S′ of the moving body 2. The line-of-sight direction L may be determined based on, for example, a predetermined reference.

The line-of-sight direction L only has to be, for example, a direction from the virtual viewpoint O toward the detection point P closest to the planned self-position S′ of the moving body 2. The line-of-sight direction L may be a direction that passes through the detection point P and is perpendicular to the deformed projection surface 42. The virtual viewpoint line-of-sight information indicating the virtual viewpoint O and the line-of-sight direction L is created by the virtual viewpoint line-of-sight determination module 34.

The image combining module 38 generates a combined image obtained by extracting a part or all of the virtual viewpoint image. For example, the image combining module 38 performs processing of combining a plurality of virtual viewpoint images (here, four virtual viewpoint images corresponding to the imaging units 12A to 12D) in boundary regions among the imaging units.

The image combining module 38 outputs the generated combined image to the display unit 16. Note that the combined image may be a bird's-eye view image in which the upper side of the moving body 2 is the virtual viewpoint O or may be a bird's-eye view image in which the inside of the moving body 2 is the virtual viewpoint O and the moving body 2 is displayed translucently.

### Projection Surface Deformation Processing Based on an Action Plan

Next, a flow of projection surface deformation processing based on an action plan executed by the information processing device 10 according to the present embodiment is explained. The projection surface deformation processing based on the behavior plan does not perform the projection surface deformation processing with reference to the self-position of the moving body 2 obtained by the VSLAM processing but performs the projection surface deformation processing with reference to a planned self-position in a fixed period (in future) ahead obtained by the behavior plan.

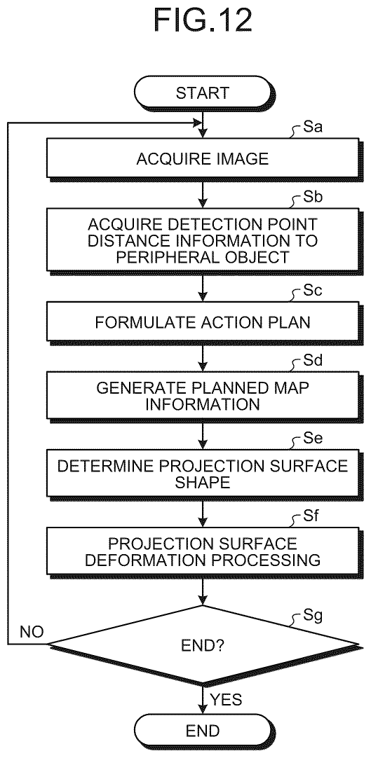

FIG. 12 is a flowchart illustrating an example of a flow of the projection surface deformation processing based on the action plan. Note that an overall flow of detailed bird's-eye view image generation processing executed by the information processing device 10 is explained in detail later.

First, a captured image is acquired (Step Sa). The VSLAM processor 24 generates environmental map information with VSLAM processing using the captured image and the distance conversion module 27 acquires detection point distance information (Step Sb).

The planning processing module 28A formulates an action plan based on the detection point distance information (Step Sc).

The planned map information generation module 28B generates planned map information based on the planned self-position information and the detection point distance information acquired from the planning processing module 28A (Step Sd).

The determination module 30 determines a shape of the projection surface using the planned map information (Step Se).

The deformation module 32 executes projection surface deformation processing based on the projection shape information (Step Sf).

The processing from Step Sa to Step Sf is sequentially repeatedly executed until, for example, driving assistance processing using the bird's-eye view image ends (Step Sg).

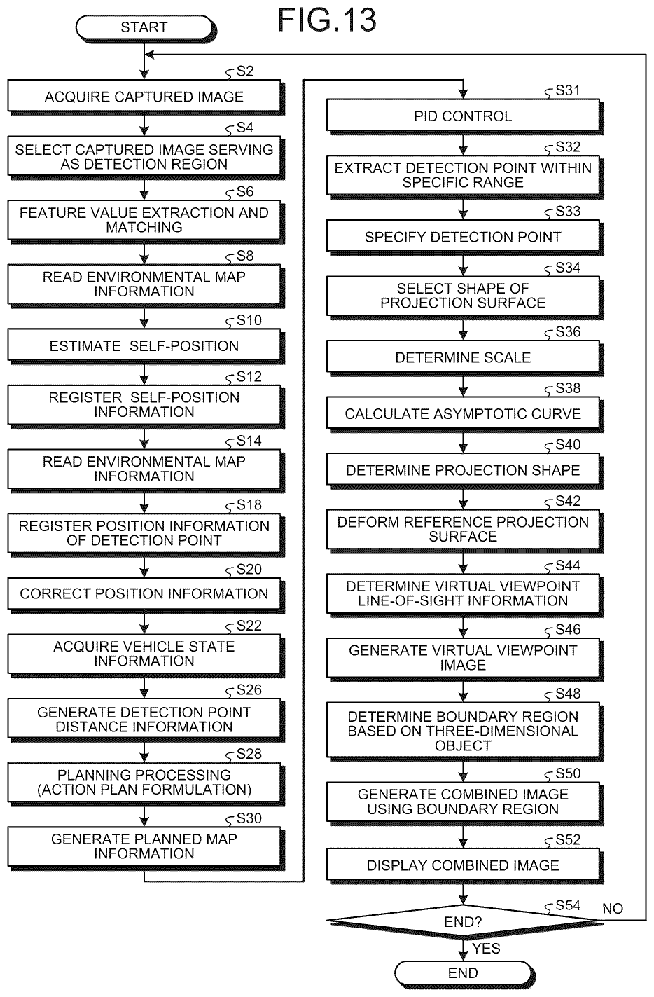

FIG. 13 is a flowchart illustrating an example of a flow of bird's-eye view image generation processing including the projection surface deformation processing based on the action plan, which is executed by the information processing device 10.

The acquisition module 20 acquires a captured image in each direction from the imaging unit 12 (Step S2). The selection module 21 selects the captured image serving as a detection region (Step S4).

The matching module 240 performs feature value extraction and matching processing using a plurality of captured images at different imaging timings selected in Step S4 and captured by the imaging unit 12 (Step S6). The matching module 240 registers, in the storage unit 241, information concerning corresponding points among the plurality of captured images at the different imaging timings, the information being specified by the matching processing.

The self-position estimation module 242 reads the matching points and the environmental map information 241A (the surrounding position information and the self-position information) from the storage unit 241 (Step S8). The self-position estimation module 242 estimates a relative self-position with respect to the captured image with projection conversion or the like using a plurality of matching points acquired from the matching module 240 (Step S10) and registers the calculated self-position information in the environmental map information 241A (Step S12).

The three-dimensional restoration module 243 reads the environmental map information 241A (the surrounding position information and the self-position information) (Step S14). The three-dimensional restoration module 243 performs perspective projection conversion processing using a movement amount (a translation amount and a rotation amount) of the self-position estimated by the self-position estimation module 242, determines a three-dimensional coordinate (a relative coordinate with respect to the self-position) of the matching point, and registers the three-dimensional coordinate in the environmental map information 241A as surrounding position information (Step S18).

The correction module 244 reads the environmental map information 241A (the surrounding position information and the self-position information). The correction module 244 corrects, for points matched a plurality of times among a plurality of frames, the surrounding position information and the self-position information registered in the environmental map information 241A (Step S20) using, for example, the least squares method such that the sum of the differences of distances in the three-dimensional space is minimized between a three-dimensional coordinate calculated in the past and a three-dimensional coordinate calculated anew and updates the environmental map information 241A.

The distance conversion module 27 captures speed data (own vehicle speed) of the moving body 2 included in CAN data received from the ECU 3 of the moving body 2 (Step S22). The distance conversion module 27 converts a coordinate distance between point groups included in the environmental map information 241A into, for example, an absolute distance in meter unit using the speed data of the moving body 2. The distance conversion module 27 offsets the origin of the environmental map information to the self-position S of the moving body 2 and generates detection point distance information indicating the distance from the moving body 2 to each of the plurality of detection points P (Step S26). The distance conversion module 27 outputs the detection point distance information to the action plan formulation module 28.

The planning processing module 28A executes planning processing and formulates a parking route from a current position of the moving body 2 to parking completion for parking the moving body 2 in a parking region, a planned self-position of the moving body 2 after a unit time, which is a most recent target point obtained by engraving the parking route, a target value of an actuator such as most recent acceleration or turn angle for reaching the most recent target point, and the like (Step S28).

The planned map information generation module 28B offsets the origin (the current self-position S) of the detection point distance information to the planned self-position S′ of the moving body 2 predicted after the unit time elapses to generate planned map information and deliver the planned map information to the extraction module 305 (Step S30).

The PID control module 28C performs PID control based on the actuator target value formulated by the planning processing module 28A and delivers the actuator control value to the actuator (Step S31).

The extraction module 305 extracts the detection point P present within a specific range among the detection point distance information (Step S32).

The nearest neighbor specifying module 307 divides the periphery of the planned self-position S′ of the moving body 2 for each specific range, specifies, for each range, the detection point P closest to the planned self-position S′ of the moving body 2 or a plurality of detection points P in order of closeness to the planned self-position S′ of the moving body 2 and extracts a distance between the planned self-position S′ and the nearest neighbor object (Step S33). The nearest neighbor specifying module 307 outputs the measurement distance d of the detection point P identified for each range (the measurement distance between the planned self-position S′ of the moving body 2 and the nearest object) to the reference projection surface shape selection module 309, the scale determination module 311, the asymptotic curve calculation module 313, and the boundary region determination module 317.

The reference projection surface shape selection module 309 selects the shape of the reference projection surface 40 (Step S34) and outputs shape information of the selected reference projection surface 40 to the shape determination module 315.

The scale determination module 311 determines a scale of the reference projection surface 40 having the shape selected by the reference projection surface shape selection module 309 (Step S36) and outputs scale information of the determined scale to the shape determination module 315.

The asymptotic curve calculation module 313 calculates an asymptotic curve (Step S38) and outputs the asymptotic curve to the shape determination module 315 and the virtual viewpoint line-of-sight determination module 34 as asymptotic curve information.

The shape determination module 315 determines, based on the scale information and the asymptotic curve information, a projection shape indicating how to deform the shape of the reference projection surface (Step S40). The shape determination module 315 outputs projection shape information of the determined projection shape 41 to the deformation module 32.

The deformation module 32 deforms the shape of the reference projection surface based on the projection shape information (Step S42). The deformation module 32 outputs the deformed projection surface information to the projection conversion module 36.

The virtual viewpoint line-of-sight determination module 34 determines virtual viewpoint line-of-sight information based on the planned self-position S′ and the asymptotic curve information (Step S44). The virtual viewpoint line-of-sight determination module 34 outputs the virtual viewpoint line-of-sight information indicating the virtual viewpoint O and the line-of-sight direction L to the projection conversion module 36.

The projection conversion module 36 generates a projection image obtained by projecting a captured image acquired from the imaging unit 12 on the deformed projection surface based on the deformed projection surface information and the virtual viewpoint line-of-sight information. The projection conversion module 36 converts the generated projection image into a virtual viewpoint image (Step S46) and outputs the virtual viewpoint image to the image combining module 38.

The boundary region determination module 317 determines a boundary region based on the distance from the planned self-position S′ to the nearest object specified for each range. That is, the boundary region determination module 317 determines, based on the position of the object closest to the planned self-position S′ of the moving body 2, a boundary region serving as a superimposition region of spatially adjacent peripheral images (Step S48). The boundary region determination module 317 outputs the determined boundary region to the image combining module 38.

The image combining module 38 combines virtual viewpoint images spatially adjacent to each other using the boundary region to generate a combined image (Step S50). Note that, in the boundary region, the virtual viewpoint images spatially adjacent to each other are blended at a predetermined ratio.

The display unit 16 displays the combined image (Step S52).

The information processing device 10 determines whether to end the information processing (Step S54). For example, the information processing device 10 discriminates whether a signal indicating parking completion of the moving body 2 has been received from the ECU 3 or the planning processing module 28A to perform the determination in Step S54. For example, the information processing device 10 may discriminate whether an instruction to end the information processing has been received by an operation instruction or the like by the user to perform the determination in Step S54.

When a negative determination is made in Step S54 (Step S54: No), the processing in Step S2 to Step S54 is repeatedly executed. On the other hand, when an affirmative determination is made in Step S54 (Step S54: Yes), this routine is ended.

Note that, when the processing returns from Step S54 to Step S2 after the correction processing in Step S20 is executed, the subsequent correction processing in Step S20 may be sometimes omitted. When the processing returns from Step S54 to Step S2 without executing the correction processing in Step S20, the subsequent correction processing in Step S20 may be sometimes executed.

Next, action effects of the information processing device 10 according to the embodiment is explained using a comparative example.

The information processing device 10 according to the embodiment includes the VSLAM processor 24, the action plan formulation module 28, and the shape determination module 315 that is a part of the projection shape determination module 29. The VSLAM processor 24 generates second information (environmental map information) including position information of the peripheral three-dimensional objects of the moving body 2 and position information of the moving body 2 based on an image of the periphery of the moving body 2. Based on the action plan information of the moving body, the action plan formulation module 28 generates first information including the planned self-position information of the moving body 2 and the position information of the peripheral three-dimensional objects based on the planned self-position information. Based on the first information, the projection shape determination module 29 determines a shape of the projection surface on which an image acquired from the imaging unit 12 is projected to generate a bird's-eye view image.

Therefore, the information processing device 10 generates planned map information for calculating a distance of a detection point with reference to the planned self-position formulated by the action plan formulation module 28 rather than the self-position acquired by the VSLAM processing and determines, using the planned map information, a shape of the projection surface for generating the bird's-eye view image.

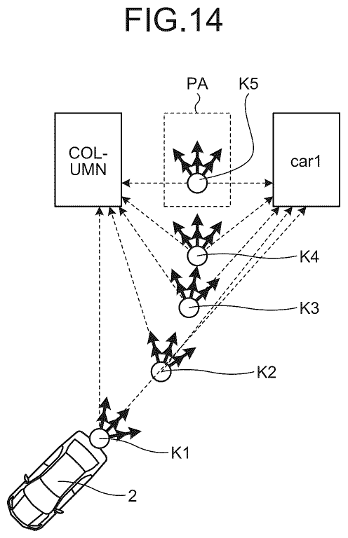

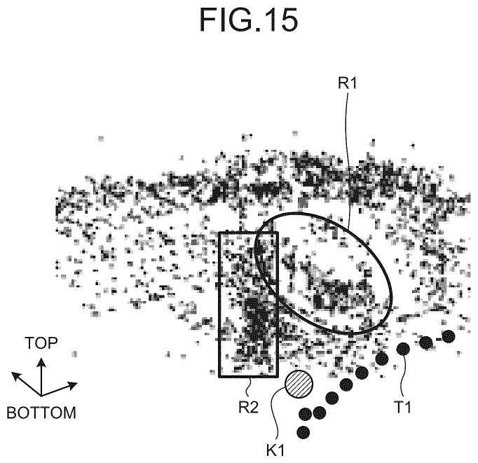

FIG. 14 and FIG. 15 are diagrams for explaining projection surface deformation processing executed by an information processing device according to a comparative example. Here, a case in which detection point distance information, which is an output of the distance conversion module 27, is input to the determination module 30 not via the action plan formulation module 28 is explained. FIG. 14 is a top view of a situation in which the moving body 2 in this case is parked backward in the parking region PA located between a pillar and the car 1. FIG. 15 is a schematic diagram illustrating an example of detection point distance information based on a self-position K1 acquired by the VSLAM processing.

As illustrated in FIG. 14, a case in which the moving body 2 moves backward from the position K1 to positions K2, K3, K4, and K5 is assumed. In such a case, for example, the information processing device according to the comparative example starts the VSLAM processing at timing when the moving body 2 is located at the position K1 and generates and displays a bird's-eye view image based on a result of the projection surface deformation processing based on the self-position K1.

However, the VSLAM processing is performed based on a peripheral image acquired at the timing when the moving body 2 is located at the position K1. The moving body 2 has already moved from the position K1 toward the position K2 by timing when the bird's-eye view image based on the result of the projection surface deformation processing based on the self-position K1 is displayed. Therefore, at timing when the bird's-eye view image based on the result of the projection surface deformation processing based on the self-position K1 is actually displayed, the moving body 2 is not located at the position K1. For example, at the self-position K2, a bird's-eye view image based on the shape of a projection surface determined based on the self-position K1 in the past is displayed on the display unit 16. As explained above, at a point in time when the bird's-eye view image is displayed, the projection surface shape using the distance information calculated based on the point in time in the past is obtained and the bird's-eye view image is sometimes unnatural.

When the moving body 2 performs backward parking in a route illustrated in FIG. 14, vehicle speed between the position K1 and the position K5 is not constant. For example, at K1, the moving body 2 accelerates by starting to move backward and then moves backward at constant speed. At K2, the moving body 2 decelerates by approaching the pillar and the car 1. At K3, while the moving body 2 is prevented from coming into contact with the pillar and the car 1, the turning of the moving body 2 is controlled and the moving body 2 decelerates such that the longitudinal direction of a parking position PA and the backward moving direction of the moving body 2 become parallel. At K4, the moving body 2 accelerates as the backward moving direction of the moving body 2 and the longitudinal direction of the parking position PA become parallel. At K5, the moving body 2 decelerates to stop at the parking position PA. In this manner, the vehicle speed of the moving body 2 continues to change. Accordingly, fluctuation in a video appears in the bird's-eye view image using the projection surface shape based on the distance information calculated based on the point in time in the past. For example, when the moving body 2 moves forward once according to, for example, turning back of a steering wheel while the moving body 2 moves from the position K3 to the position K4, fluctuation in a video sometimes further occurs.

In contrast, the information processing device 10 according to the embodiment performs the projection shape deformation based on the planned self-position information formulated by the action plan formulation module 28 and also used to determine a control value of the actuator. Accordingly, the difference between an actual position of the moving body 2 at timing when the bird's-eye view image is displayed on the display unit 16 and the self-position of the moving body 2 in the distance information used for the deformation of the projection surface shape of the bird's-eye view image is suppressed. Therefore, unnatural fluctuation of the projection surface shape can be suppressed. As a result, when the projection surface of the bird's-eye view image is sequentially deformed according to a three-dimensional object around the moving body, a more natural bird's-eye view image can be provided compared with the related art.

The information processing device 10 according to the embodiment generates environmental map information including self-position information and surrounding position information with the VSLAM processing using an image acquired by the acquisition module 20. The action plan formulation module 28 generates planned map information based on the planned self-position of the moving body 2 based on the self-position information and the surrounding position information. Therefore, with a relatively simple configuration using only the image from the imaging unit 12, it is possible to generate a planned map information based on the planned self-position of the moving body 2.

The information processing device 10 according to the embodiment generates control values for the actuator such as acceleration, braking, gearing, and turning, which are third information concerning control of the moving body 2, based on the action plan information of the moving body 2. Therefore, the movement control for the moving body 2 and the deformation of the projection surface based on the planned self-position of the moving body 2 can be associated. As a result, it is possible to provide a continuous and natural bird's-eye view image involved in the movement of the moving body 2.

### Modification 1

The projection surface deformation processing based on an action plan is executed based on planned self-position in how long period ahead (in future) can be optionally adjusted by changing the planned self-position based on which the planned map information is generated.

### Modification 2

In the embodiment explained above, a case in which an action plan is formulated in response to a selection instruction of an automatic parking mode from a driver and projection surface deformation processing based on the action plan is executed is taken as an example. However, the projection surface deformation processing based on the action plan is not limited to the automatic parking mode or the automatic driving mode and can also be used in the case in which the driver is assisted by a bird's-eye view image in a semi-automatic driving mode, a manual driving mode, and the like. The projection surface deformation processing can be used not only in backward parking but also in the case in which the driver is assisted by a bird's-eye view image in tandem parking and the like.

### Second Embodiment

The information processing device 10 according to a second embodiment executes projection surface deformation processing based on an action plan using not only data obtained by VSLAM processing but also data acquired from at least one external sensor. Note that, in the following explanation, to make explanation specific, a case in which the information processing system 1 includes a millimeter wave radar, a sonar, and a GPS sensor as external sensors is taken as an example.

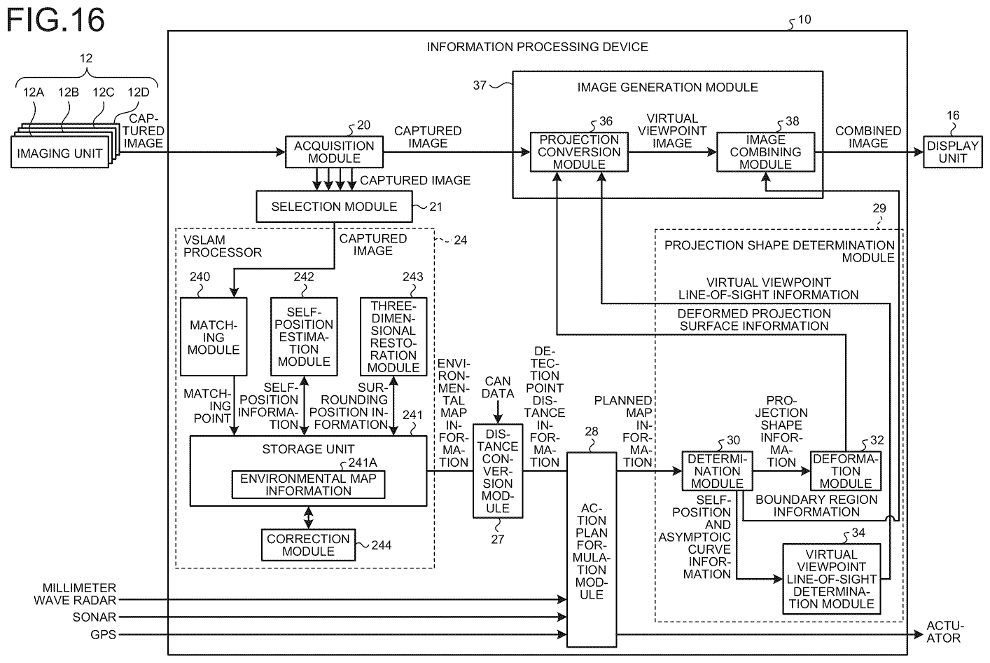

FIG. 16 is a schematic diagram illustrating an example of a functional configuration of the information processing device 10 according to the second embodiment. As illustrated in FIG. 16, each data from the millimeter wave radar, the sonar, and the GPS sensor as the external sensors is input to the action plan formulation module 28.

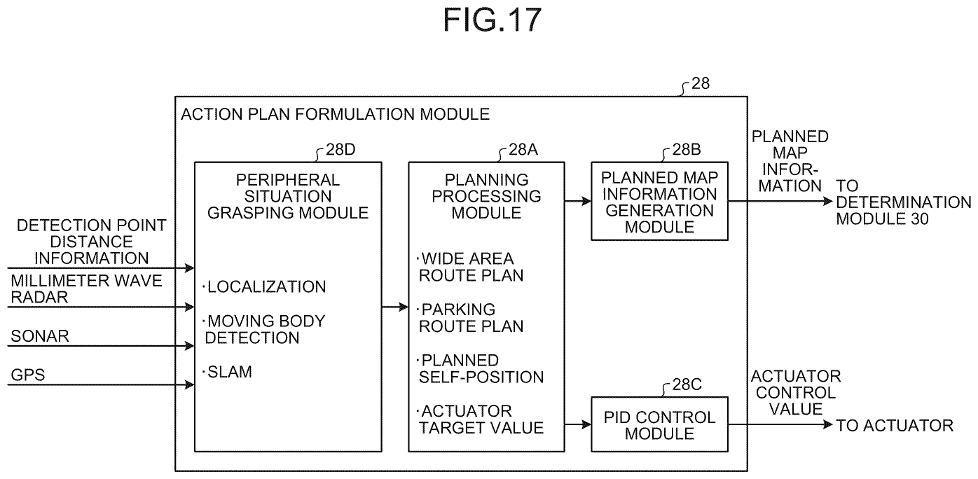

FIG. 17 is a schematic diagram illustrating an example of a functional configuration of the action plan formulation module 28 of the information processing device 10 according to the second embodiment. As illustrated in FIG. 17, the action plan formulation module 28 includes a peripheral situation grasping module 28D, the planning processing module 28A, the planned map information generation module 28B, and the PID control module 28C.

Using data from the VSLAM processor 24 and data from the millimeter wave radar, the sonar, and the GPS sensor, the peripheral situation grasping module 28D executes localization processing for a wide area and SLAM processing in addition to moving body detection processing and generates self-position information and surrounding position information with higher accuracy compared with the first embodiment. Note that the self-position information and the surrounding position information include distance information obtained by converting the distance between the moving body 2 and a peripheral three-dimensional object of the moving body 2 into, for example, meter unit. The localization processing for the wide area means processing of acquiring self-position information of the moving body 2 in a wider range than the self-position information acquired by the VSLAM processing using, for example, data acquired from the GPS sensor.

The planning processing module 28A executes planning processing based on the self-position information and the surrounding position information from the peripheral executed by the planning processing module 28A includes parking route planning processing, wide area route planning processing, planned self-position calculation processing along a route plan, and actuator target value calculation processing. The wide area route planning processing is a route plan at the time when the moving body 2 travels on a road or the like and moves in a wide area.

The planned map information generation module 28B generates planned map information using the surrounding position information generated by the peripheral situation grasping module 28D and the planned self-position information formulated by the planning processing module 28A and delivers the planned map information to the determination module 30.

The PID control module 28C performs PID control based on an actuator target value formulated by the planning processing module 28A and delivers an actuator control value for controlling an actuator such as acceleration or a turning angle.

The information processing device 10 according to the second embodiment explained above grasps a peripheral situation with higher accuracy using not only the data obtained by the VSLAM processing but also the data from the millimeter wave radar, the sonar, and the GPS sensor and executes the projection surface deformation processing based on the action plan. Therefore, in addition to the information processing device 10 according to the first embodiment, it is possible to implement driving assistance by a bird's-eye view image with higher accuracy.

### Third Embodiment

The information processing device 10 according to a third embodiment executes projection surface deformation processing based on an action plan using an image acquired by the imaging unit 12 and data acquired from at least one external sensor. Note that, in the following explanation, to make explanation specific, a case in which the information processing system 1 includes a LiDAR, a millimeter wave radar, a sonar, and a GPS sensor as external sensors is taken as an example. The information processing device 10 may perform projection surface deformation processing based on only the image and the action plan acquired by the imaging unit 12.

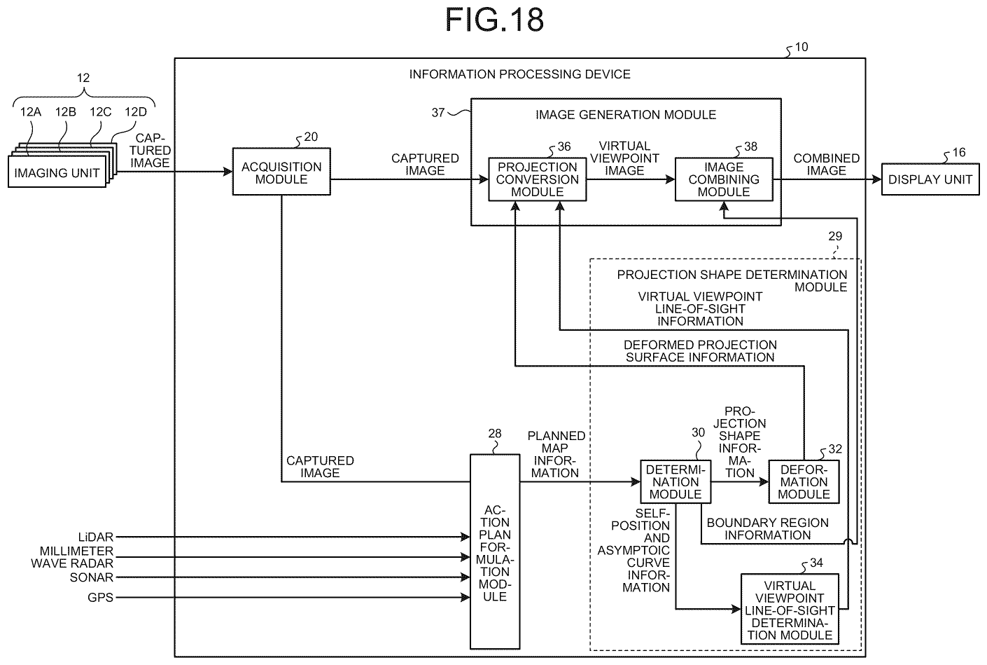

FIG. 18 is a schematic diagram illustrating an example of a functional configuration of the information processing device 10 according to the third embodiment. As illustrated in FIG. 18, the image acquired by the imaging unit 12 is input to the action plan formulation module 28 via the acquisition module 20. Data from the LiDAR, millimeter wave radar, sonar, and GPS sensors serving as external sensors are input to the action plan formulation module 28.

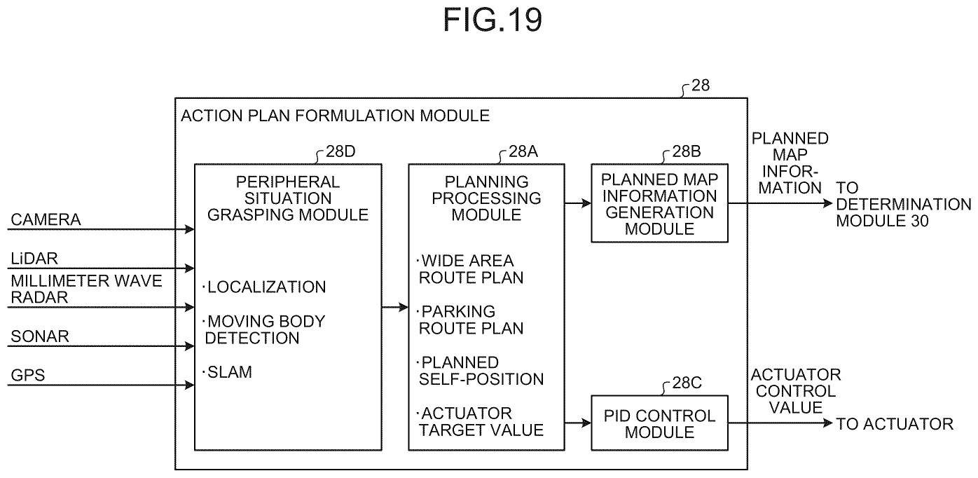

FIG. 19 is a schematic diagram illustrating an example of a functional configuration of the action plan formulation module 28 of the information processing device 10 according to the third embodiment. As illustrated in FIG. 19, the action plan formulation module 28 includes the peripheral situation grasping module 28D, the planning processing module 28A, the planned map information generation module 28B, and the PID control module 28C.

The peripheral situation grasping module 28D executes moving body detection processing, localization processing, and SLAM processing (including VSLAM processing) using the image acquired by the imaging unit 12 and the data from LiDAR, millimeter wave radar, sonar, and GPS sensor and generates self-position information and surrounding position information. Note that the self-position information and the surrounding position information include distance information obtained by converting the distance between the moving body 2 and a peripheral three-dimensional object of the moving body 2 into, for example, meter unit.

The planning processing module 28A executes planning processing based on the self-position information and the surrounding position information from the peripheral executed by the planning processing module 28A includes parking route planning processing, wide area route planning processing, planned self-position calculation processing along a route plan, and actuator target value calculation processing.

The planned map information generation module 28B generates planned map information using the surrounding position information generated by the peripheral situation grasping module 28D and the planned self-position information formulated by the planning processing module 28A and delivers the planned map information to the determination module 30.

The PID control module 28C performs PID control based on an actuator target value formulated by the planning processing module 28A and delivers an actuator control value for controlling an actuator such as acceleration or a turning angle.

The information processing device 10 according to the third embodiment explained above grasps a peripheral situation with higher accuracy using the image acquired by the imaging unit 12 and the data from the LiDAR, the millimeter wave radar, the sonar, and the GPS sensor and executes the projection surface deformation processing based on the action plan. Therefore, in addition to the information processing device 10 according to the first embodiment, it is possible to implement driving assistance by a bird's-eye view image with higher accuracy.

Although the embodiments and the modifications are explained above, the information processing device, the information processing method, and the computer program product disclosed in the present application are not limited to the embodiments and the like explained above per se. The components can be modified and embodied in implementation stages and the like without departing from the gist the embodiments and the like. In addition, various inventions can be formed by appropriate combinations of a plurality of constituent elements disclosed in the embodiments and the modifications explained above. For example, several constituent elements may be deleted from all the constituent elements explained in the embodiments.

Note that the information processing device 10 in the embodiments and the modifications explained above can be applied to various apparatuses. For example, the information processing device 10 in the embodiments and the modifications can be applied to a monitoring camera system that processes a video obtained from a monitoring camera, an in-vehicle system that processes an image of a peripheral environment outside a vehicle, or the like.

According to one aspect of the image processing device disclosed in the present application, it is possible to provide a bird's-eye view image more natural compared with the related art when the projection surface of the bird's-eye view image is sequentially deformed according to the three-dimensional object around the moving body.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing device comprising:
an action plan formulation module configured to generate, based on action plan information of a moving body, first information including planned self-position information indicating a planned self-position of the moving body and position information of a peripheral three-dimensional object based on the planned self-position information; and
a projection shape determination module configured to determine, based on the first information, a shape of a projection surface on which a first image acquired by an imaging device mounted on the moving body is projected to generate a bird's-eye view image.

2. The image processing device according to claim 1, wherein the action plan formulation module is configured to generate the first information based on second information and the action plan information, the second information including position information of a peripheral three-dimensional object of the moving body and position information of the moving body.

3. The image processing device according to claim 2, wherein the second information includes information generated by VSLAM processing using a second image around the moving body.

4. The image processing device according to claim 3, wherein the first image includes an image different from the second image.

5. The image processing device according to claim 2, wherein the second information includes information generated by SLAM processing using data acquired from at least one external sensor.

6. The image processing device according to claim 2, further comprising a control information generation module configured to generate third information concerning control of the moving body based on the action plan information of the moving body and the second information, wherein the moving body is controlled based on the third information.

7. The image processing device according to claim 1, wherein the projection shape determination module is configured to determine the shape of the projection surface based on distance information between position information of the peripheral three-dimensional object and the planned self-position.

8. The image processing device according to claim 7, wherein the projection shape determination module is configured to determine the shape of the projection surface based on the peripheral three-dimensional object at a position closest to the planned self-position of the moving body.

9. An image processing method executed by a computer, the method comprising:
generating, based on action plan information of a moving body, first information including planned self-position information indicating a planned self-position of the moving body and position information of a peripheral three-dimensional object based on the planned self-position information; and
determining, based on the first information, a shape of a projection surface on which a first image acquired by an imaging device mounted on the moving body is projected to generate a bird's-eye view image.

10. A computer program product including programmed instructions embodied in and stored on a non-transitory computer readable medium, the instructions, when executed by a computer, causing the computer to perform:
generating, based on action plan information of a moving body, first information including planned self-position information indicating a planned self-position of the moving body and position information of a peripheral three-dimensional object based on the planned self-position information; and
determining, based on the first information, a shape of a projection surface on which a first image acquired by an imaging device mounted on the moving body is projected to generate a bird's-eye view image.
